(19) United States
(12) Patent Application Publication
(10) Pub. No.: US 2025/0135452 A1
(43) Pub. Date: May 1, 2025

(54) AUTOMATED ANALYTE MEASUREMENT SYSTEMS AND KITS FOR USE THEREWITH

(71) Applicant: Correlia Biosystems, Inc., Berkeley, CA (US)

(72) Inventors: M. Kursad Araz, El Cerrito, CA (US); Pranav Sundaram, Berkeley, CA (US); Robert Ray, Oakland, CA (US); Akwasi A. Apori, Oakland, CA (US); Samuel Quinn Tia, Berkeley, CA (US)

(21) Appl. No.: 18/835,321

(22) PCT Filed: Feb. 3, 2023
(86) PCT No.: PCT/US2023/012340

§ 371 Date: Aug. 1, 2024

Related U.S. Application Data
(60) Provisional application No. 63/306,467, filed on Feb. 3, 2022.
(60) Provisional application No. 63/306,427, filed on Feb. 3, 2022.

(51) Int. Cl. B01L 3/00; G01N 35/00; G01N 35/02; G01N 35/10

(52) U.S. Cl. CPC B01L 3/5025; G01N 35/0099; G01N 35/028; G01N 35/1009; G01N 35/1074; B01L 2300/0829; B01L 2400/049

(57) ABSTRACT

A chip module configured for use with a fluid sample processing system can include one or more assay devices arranged into one or more rows. The assay device(s) can include one or more wells configured to hold fluid therein and one or more aspiration channels connected to the well(s). The aspiration channel(s) can be configured to aspirate fluid from the bottoms or the sides of the well(s). The assay device(s) can be arranged within a frame in the chip module, which can be removable from the fluid sample processing system. This chip module can also include one or more trenches beneath the aspiration channel(s). the trench(es) being configured to facilitate the aspiration of fluid from multiple wells. A hydrophobic material can be included in the aspiration channel(s) and/or trench(es) to hold the fluid therein without the fluid passing through the aspiration channel(s) during analytic measurements on the fluid.

### CROSS-REFERENCE TO RELATED APPLICATIONS

This application claims the benefit of U.S. Provisional Patent Application No. 63/306,467 filed Feb. 3, 2022, entitled “AUTOMATED ANALYTE MEASUREMENT SYSTEMS AND KITS FOR USE THEREWITH,” which application is hereby incorporated by reference in its entirety herein. This application also claims the benefit of U.S. Provisional Patent Application No. 63/306,427 filed Feb. 3, 2022, entitled “SYSTEM MODULES FOR USE WITH FLUID SAMPLE PROCESSING SYSTEMS,” which application is hereby incorporated by reference in its entirety herein.

### TECHNICAL FIELD

The present disclosure relates generally to fluid sample processing, and more particularly to components for analyte measurement systems.

### BACKGROUND

Fluid sample processing can involve the detection, identification and quantification of small molecules and macromolecules in fluid samples for purposes of research, clinical applications, diagnosis, treatment, and related endeavors. Such molecules and macromolecules can include, for example, proteins, peptides, antibodies, nucleic acid markers, hormones, metabolites, carbohydrates, lipids, and the like. Commercially available fluid processing systems can include various robotically controlled components for the delivery, analysis, removal, and disposal of fluids of interest. Such fluids are commonly delivered to assay chips using an array of pipets, where the fluids are then analyzed and then removed using the same or a different array of pipets.

Unfortunately, there are several drawbacks to conventional fluid processing systems. In such systems, fluids are commonly delivered to the tops of the assay chips by way of pipets and then aspirated or otherwise removed from the tops of the chips by pipets. This process can be time consuming, involving many steps, and fluid removal can often be inaccurate, resulting in residual fluids left behind. Furthermore, while many such fluid processing systems are robotically controlled to some extent, these systems still inconveniently require a significant amount of manual intervention and steps. For example, some arrays of assay chips require a user or operator to stop an automated process to intervene manually in order to remove or replace parts of the chip array before the processing and analysis of further fluids. This can be disadvantageously time consuming, labor intensive, and prone to operator error.

Although traditional fluid sample processing systems and processing techniques have worked well in the past, improvements are always helpful. In particular, what is desired are improved fluid sample processing systems and components thereof that facilitate faster, more automated, and more accurate fluid sample processing, with little to no residual fluids.

### SUMMARY

It is an advantage of the present disclosure to provide improved fluid sample processing systems and components thereof that facilitate faster, more automated, and more accurate fluid sample processing, with little to no residual fluids. The disclosed systems, apparatuses, methods, and features thereof include fluid processing components that provide faster, more automated, and more accurate fluid aspiration from assay chips during fluid processing. This can be accomplished at least in part due to assay chip modules having innovative aspiration channels and associated components that facilitate improved aspiration through these aspiration channels.

In various embodiments of the present disclosure, a fluid sample processing system can include an analytic component and a removable chip module. The removable chip module can be configured to be coupled to the analytic component and can have one or more assay devices arranged into one or more rows. The one or more assay devices can include one or more wells configured to hold fluid therein and one or more aspiration channels connected to the one or more wells. The one or more aspiration channels can be configured to aspirate fluid from the bottoms or the sides of the one or more wells.

In various detailed embodiments, the one or more assay devices can be arranged within a frame in the removable chip module. The removable chip module can further include one or more trenches beneath the one or more aspiration channels, with the one or more trenches being configured to facilitate the aspiration of fluid from multiple wells. Aspiration from multiple wells can be configured to occur simultaneously. At least one of the one or more aspiration channels can define a cylindrical channel that extends from the bottom of a well and has a diameter of about 100-300 microns.

In various further embodiments of the present disclosure, a chip module configured for use with a fluid sample processing system can include one or more assay devices arranged into one or more rows. The one or more assay devices can include one or more wells configured to hold fluid therein and one or more aspiration channels connected to the one or more wells. The one or more aspiration channels can be configured to aspirate fluid from the bottoms or the sides of the one or more wells.

In various detailed embodiments, the one or more assay devices can be arranged within a frame in the chip module. Also, the chip module can be configured to be removable from the fluid sample processing system. The chip module can also include one or more trenches beneath the one or more aspiration channels, with the one or more trenches being configured to facilitate the aspiration of fluid from multiple wells. In some arrangements, the one or more wells can be configured to hold the fluid therein without the fluid passing through the one or more aspiration channels during analytic measurements on the fluid. This can involve at least a portion of the chip module downstream of the one or more wells having a hydrophobic material configured to hold the fluid in the wells during analytic measurements on the fluid. This can include at least a portion of the one or more aspiration channels having a hydrophobic material configured to prevent the fluid from entering therein during analytic measurements on the fluid. Aspiration from multiple wells can be configured to occur simultaneously. Aspiration from multiple wells can also be configured to occur by applying a vacuum beneath the one or more aspiration channels. Also, at least one of the one or more aspiration channels can define a cylindrical channel that extends from the bottom of a well and has a diameter of about 100-300 microns. In various arrangements, the chip module can also include at least one flexible electrode arrangement having one or more electrode components configured to provide an electrical charge to the one or more wells. The one or more electrode components can comprise one or more tabs configured to bend into the one or more wells.

In still further embodiments of the present disclosure, various methods of processing fluid samples are provided. Pertinent method steps can include providing a removable chip module within a fluid sample processing system, the removable chip module including one or more assay devices arranged into one or more rows, the one or more assay chips including one or more wells configured to hold fluid therein and one or more aspiration channels connected to the one or more wells, placing a fluid into the top of each of the one or more wells, analyzing content in the fluid within the one or more wells, and aspirating the fluid from the bottom or the side of each of the one or more wells.

In various detailed embodiments, the aspirating can be facilitated by applying a vacuum to the bottom or the side of each of the one or more wells. Also, the placing, the analyzing, and the aspirating steps can all automatically be performed by a robotic system. Further, the aspirating of the fluid occurs simultaneously for all of the one or more wells. In some arrangements, the method can also include the step removing the removable chip module from the fluid sample measurement system.

Other apparatuses, methods, features, and advantages of the disclosure will be or will become apparent to one with skill in the art upon examination of the following figures and detailed description. It is intended that all such additional apparatuses, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible structures and arrangements for the disclosed systems, apparatuses, features, and methods relating to fluid sample processing. These drawings in no way limit any changes in form and detail that may be made to the disclosure by one skilled in the art without departing from the spirit and scope of the disclosure.

FIG. 1 illustrates in schematic view an example fluid sample processing system.

FIG. 2A illustrates in front perspective view an example fluid sample processing system according to one embodiment of the present disclosure.

FIG. 2B illustrates in alternative perspective view the fluid sample processing system of FIG. 2A according to one embodiment of the present disclosure.

FIG. 3 illustrates in front perspective view an example system module for a fluid sample processing system according to one embodiment of the present disclosure.

FIG. 4A illustrates in front perspective view the system module of FIG. 3 as opened with a chip module inside according to one embodiment of the present disclosure.

FIG. 4B illustrates in front perspective view the system module of FIG. 3 as closed with a chip module inside according to one embodiment of the present disclosure.

FIG. 5 illustrates in top perspective view an example chip module according to one embodiment of the present disclosure.

FIG. 6A illustrates in exploded view the chip module of FIG. 5 according to one embodiment of the present disclosure.

FIG. 6B illustrates in top plan view an example flexible electrode arrangement according to one embodiment of the present disclosure.

FIG. 6C illustrates in top perspective close-up view example flexible electrodes from the flexible electrode arrangement of FIG. 6B according to one embodiment of the present disclosure.

FIG. 7 illustrates in bottom perspective view a portion of the chip module of FIG. 5 according to one embodiment of the present disclosure.

FIG. 8 illustrates in side cross-section view an example chip module within a system module according to one embodiment of the present disclosure.

FIG. 9A illustrates in side cross-section view an example chip module with aspiration channels at the bottoms of its wells according to one embodiment of the present disclosure.

FIG. 9B illustrates in side cross-section and partial cutaway view the chip module of FIG. 9A according to one embodiment of the present disclosure.

FIG. 9C illustrates in perspective cross-section view the chip module of FIG. 9A according to one embodiment of the present disclosure.

FIG. 9D illustrates in top plan view example assay chip wells having different aspiration channel configurations according to one embodiment of the present disclosure.

FIG. 9E illustrates in top cross-section view an example chip module with aspiration channels at the sides of its wells according to one embodiment of the present disclosure.

FIG. 9F illustrates in bottom cross-section view an example chip module with vent holes extending sideways from the back end of a common trench according to one embodiment of the present disclosure.

FIG. 9G illustrates in bottom cross-section view an example chip module with vent holes extending downward from the back end of a common trench according to one embodiment of the present disclosure.

FIG. 9H illustrates in perspective cross-section view an example chip module with vent holes extending upward from the back end of a common trench according to one embodiment of the present disclosure.

FIG. 10 illustrates a flowchart of an example method of processing fluid samples according to one embodiment of the present disclosure.

### DETAILED DESCRIPTION

Exemplary applications of apparatuses, systems, and methods according to the present disclosure are described in this section. These examples are being provided solely to add context and aid in the understanding of the disclosure. It will thus be apparent to one skilled in the art that the present disclosure may be practiced without some or all of these specific details provided herein. In some instances, well known process steps have not been described in detail in order to avoid unnecessarily obscuring the present disclosure. Other applications are possible, such that the following examples should not be taken as limiting. In the following detailed description, references are made to the accompanying drawings, which form a part of the description and in which are shown, by way of illustration, specific embodiments of the present disclosure. Although these embodiments are described in sufficient detail to enable one skilled in the art to practice the disclosure, it is understood that these examples are not limiting, such that other embodiments may be used, and changes may be made without departing from the spirit and scope of the disclosure.

The present disclosure relates in various embodiments to systems, apparatuses, features, and methods for fluid sample processing. In particular, the disclosed embodiments provide fluid sample processing systems and components thereof that facilitate faster, more automated, and more accurate fluid sample processing, with little to no residual fluids left behind. Such components can include assay chip modules having innovative aspiration channels and associated features that facilitate improved aspiration through these aspiration channels. The disclosed chip modules can also be removable, replaceable, and/or disposable, which advantageously facilitates ease of handling and saves time and steps in overall fluid sample processing.

Although the various embodiments disclosed herein focus on fluid sample processing involve the detection, identification and quantification of small molecules and macromolecules for purposes of simplicity in illustration, it will be readily appreciated that the disclosed systems, apparatuses, features, and methods can similarly be used for any other kind of fluid handling system. For example, the disclosed systems, apparatuses, features, and methods can be used for other fluid handling systems that can take advantage of the innovative modular and improved aspiration aspects disclosed herein to realize automated, faster, and more accurate fluid handling.

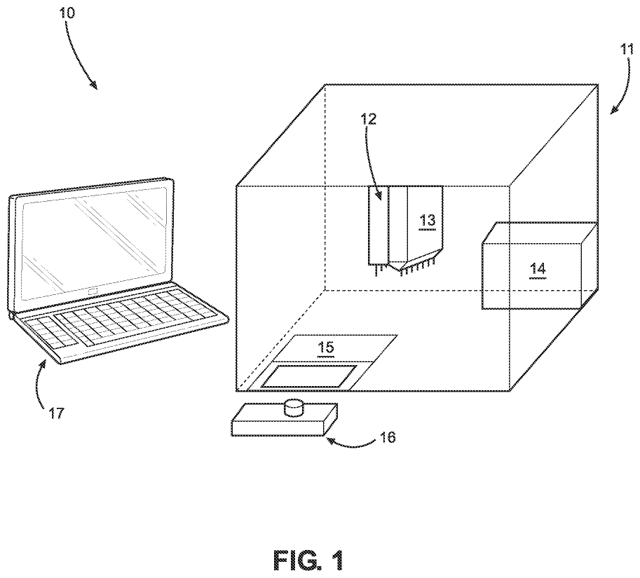

Referring first to FIG. 1, an example fluid sample processing system is shown in schematic view. Fluid sample processing system 10 can be, for example, an automated analyte detection and quantification system with direct sampling capabilities. Fluid sample processing system 10 can include a fluid handling robot contained within a frame or housing 11 configured for holding robotic components. System components can include a multichannel fluid-handling pipette 12, a robotic arm 13, various integrated components 14 (e.g., power supply, vacuum pump, etc.), a coupling arrangement 15 for a chip assay component, an associated imaging unit 16 (which may be integrated with the robot, or and external imaging unit), and an associated computer 17, among other possible components.

Various components within fluid sample processing system can be found in some commercially available automated robotic fluid sample processing systems. For example, fluid-handling pipette 12 and robotic arm 13 are available in many known systems. Fluid-handling pipet 12 can have multiple tips, such as 8, 12, 16 tips or more. This can serve to deliver fluids to many assay chips at once. Robotic arm 13 can move in x, y and z directions to move the fluid-handling pipet 12 to deliver fluids to assay chips located on a system module at docking arrangement 15. In many systems, fluid-handling pipets 12 (or another set of fluid-handling pipets) can also be used to remove fluids from the assay chips. These and other system components can be controlled by way of software and a computer, such as computer 17. Further details of a typical automated fluid sample processing system can be found in, for example, commonly owned PCT Patent Application No. PCT/US2021/14800 filed Jan. 22, 2021, and titled “AUTOMATED ANALYTE MEASUREMENT SYSTEMS AND KITS FOR USE THEREWITH,” which is incorporated by reference in its entirety herein. Still further details of automated fluid sample processing systems can be found in, for example, U.S. Pat. No. 10,634,673 to Araz et al., titled “ELECTROPHORETIC BAR CODE ASSAY DEVICES AND METHODS FOR MAKING AND USING THE SAME,” which is also incorporated by reference in its entirety herein.

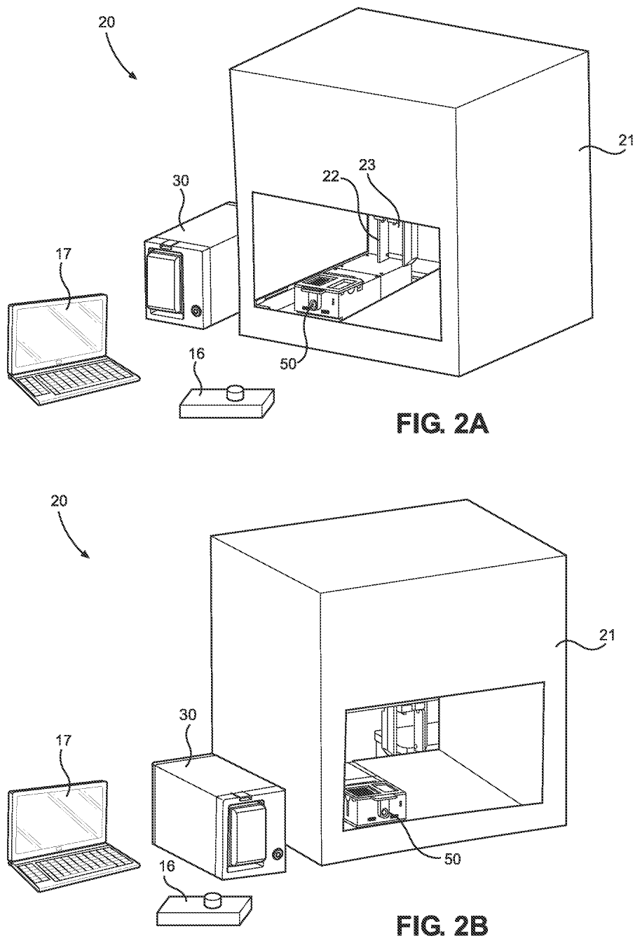

Continuing with FIGS. 2A and 2B, an example fluid sample processing system is shown in front perspective and alternative perspective views respectively. Fluid sample processing system 20 can be similar to above system 10 and can also be an automated analyte detection and quantification system with direct sampling capabilities. Fluid sample processing system 20 can also include a fluid handling robot contained within a frame or housing 21 configured for holding robotic components, which can similarly include a multichannel fluid-handling pipette 22, and a robotic arm 23. Fluid sample processing system 20 can also similarly have an associated imaging unit 16 and an associated computer 17, among other possible system components, functionalities of which will be readily understood. Associated computer 17 can have software configured to control various system functions, such as, for example, fluid sample imaging and analysis, as well as the various operations of system module 50, external box 30, and/or other possible system components, among other possible system functions. Imaging unit 16 and associated computer 17 can be considered analytic components.

Fluid sample processing system 20 as shown can be different than other fluid sample processing systems in several key aspects. Various integrated components, such as a power supply, vacuum source, waste disposal unit, and the like, can be contained in a separate external box 30 located outside housing 21. Such a separate external box 30, which can also be referred to as an “outside box” can be modular and readily installed and removed with respect to overall system 20. In addition, a system module 50 can be removably coupled inside fluid sample processing system 20, such as by way of a coupling interface. System module 50, which can also be referred to as an “on-deck module,” can be configured to be readily installed and removed with respect to overall system 20. System module 50 can also be arranged to receive and to hold assay chips for processing by the overall fluid sample processing system 20, details of which are provided below. In various arrangements, system module 50 can also be considered to be an analytic component in some regards.

In addition, fluid sample processing system 20 can be significantly different than other fluid sample processing systems with respect to the way that fluids are aspirated from the assay chips within the system. Other fluid sample processing systems traditionally aspirate or otherwise remove fluids from their assay chips from the tops of the chips by way of a pipet system, which again can be time consuming, involving many steps, with fluid removal often being inaccurate, resulting in residual fluids left behind. Conversely, fluid sample processing system aspirates fluids from its assay chips using an automated process involving aspiration channels and other features formed within a uniquely designed chip module. Such a chip module can provide improved fluid aspiration, be removable from the overall system, and be disposable, among other significant advantages. Further details of such a unique removable chip module are provided below.

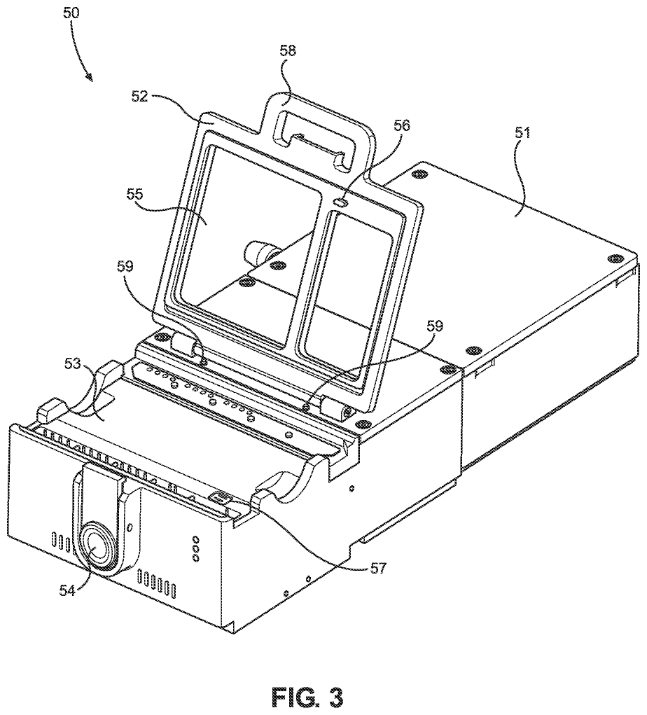

Turning next to FIG. 3, an example system module for a fluid sample processing system is illustrated in front perspective view. System module 50, which again can be readily installed and removed from an overall fluid sample processing system, can include an outer housing 51, a lid 52, a reception 53 for a removable chip module, and a release button 54, among numerous other components and features. As shown in FIG. 3, lid 52 is open and no chip module is in place within reception 53.

Lid 52 can include an access opening 55, which can be substantially sized, such that pipet access can be had to a chip module when the chip module is installed within reception 53 and the lid is closed. Lid 52 can also include a lid pin 56, which can fit through a corresponding pin hole in an installed chip module and then into a lid pin opening 57 adjacent to reception 53. Lid 52 can also include a handle 58 to facilitate the ready opening and closing of the lid. Release button 54 can be pushed to release lid 52 when the lid is in a closed position and can mechanically snap shut when the lid is closed in order to lock an installed chip module firmly in place within the system module 50. One or more spring loaded pins 59 located along reception 53 can push against lid 52, causing the lid to pop open slightly when release button 54 is pushed. Additional features and details regarding system module 50 can be found in commonly owned U.S. Patent Application No. ______ entitled “SYSTEM MODULES FOR USE WITH FLUID SAMPLE PROCESSING SYSTEMS,” which application is again hereby incorporated by reference in its entirety herein.

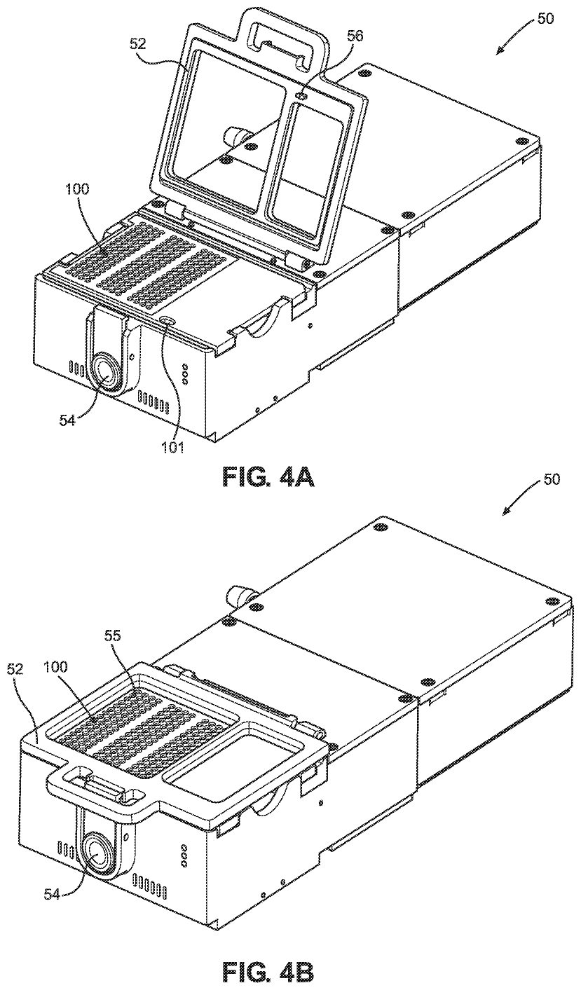

Continuing with FIGS. 4A and 4B, the system module of FIG. 3 is shown in front perspective view as opened with a chip module inside and closed with a chip module inside respectively. As shown in both figures, a removable chip module 100 has been placed or installed into the reception of system module 50. In FIG. 4A, lid 52 is open, and it can be seen that lid pin 56 inserts into pin hole 101 in removable chip module 100, which pin hole is aligned directly above the lid pin opening on the system module, as shown in FIG. 3. In FIG. 4B, lid 52 is closed and locked in place by the way of a mechanical snap lock mechanism of release button 54. Access opening 55 of lid 52 is aligned over the top of removable chip module 100, such that ready access is available to the tops of the assay chips therein. One or more sensors in system module 50 can confirm that chip module 100 is properly installed and/or that lid 52 is properly closed, such that further processing cannot take place without such confirmations. For example, chip module 100 can have a reflective sticker or other feature on its bottom, and system module 50 can have an optical sensor configured to detect such a sticker or feature to confirm that a chip module is properly installed therein.

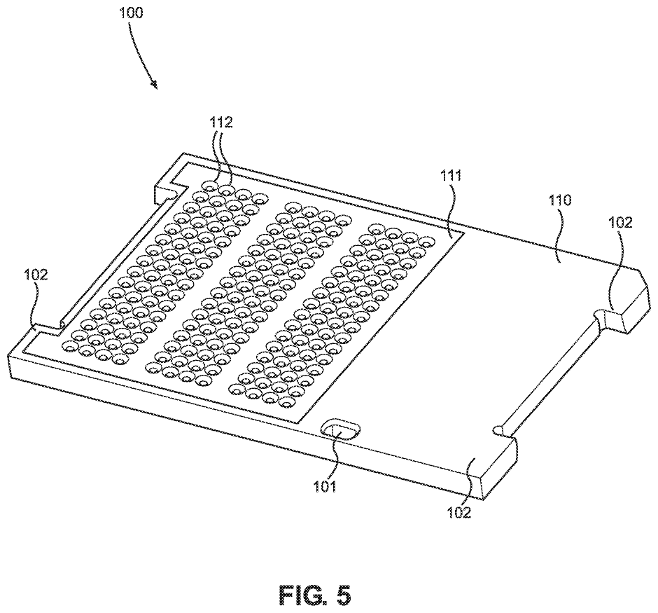

Transitioning now to FIG. 5, an example chip module according to one embodiment of the present disclosure is shown in top perspective view. Chip module 100, which can also be referred to as a “kit” or “cartridge,” can be a self-contained unit having one or more assay chips for the processing of fluids and the analysis of fluid contents. In various arrangements, chip module 100 can advantageously be readily and easily installed to and removed from an associated system module as a single unit, which can be significantly simpler and faster than the placement and removal of assay chips in conventional fluid sample processing systems. Chip module 100 can also be disposable, such that the entire chip module can be discarded after use. In some arrangements, one or more components of chip module 100 can be reused or recycled. For example, one or more frame components of chip module 100 can be cleaned after use and then used to form new chip modules.

In addition to pin hole 101 as noted above, multiple features 102 around the edges of chip module 100 can provide a unique shape that facilitates a precise fit of the chip module within an associated system module. Such features can include protrusions, recesses, and the like, the geometries of which can match the geometries around a reception in the associated system module, such as system module 50 shown above. In various arrangements, such features 102 and the overall geometry of chip module 100 can result in there being only one way for the chip module to fit within the reception of system module 50, such that the chip module cannot be installed backwards, upside down, or in some other incorrect orientation. Such a precise fit of the chip module within the system module can facilitate exact alignment with a robotic system or other automated fluid processing system, such that every different individual chip module installed into the system module will be properly aligned with respect to other components in the overall fluid processing system.

Chip module 100 can include a frame 110 and a cover plate 111 fitted in place within the frame and directly above assay chips arranged within the chip module. A plurality of cover openings 112 in cover plate 111 can each provide direct access to an individual assay chip disposed therebeneath. In some arrangements, cover openings 112 can be conically shaped to facilitate ease of insertion, guidance, and alignment for pipet tips into the wells below. In other arrangements, cover openings 112 need not be conically shaped and can form a cylindrical opening for pipet tip insertion. Other suitable shapes for cover openings 112 may also be used as may be desired. As shown, chip module can have 96 assay devices arranged into 6 rows of 16 assay devices per row. Here, each assay device can include a pair of wells connected by one or more internal channels. As will be readily appreciated though, any number of assay devices, wells, and chips arranged into any pattern can be contained within a given chip module, and other formations of assay devices can also be used. For example, a chip module having 8 rows of 12 assay devices can also be used.

In various arrangements, chip module 100 can be sized to industry standards for chip array processing. For example, chip module 100 can have a width of about 85 mm and a length of about 127 mm. Of course, other dimensions are also possible.

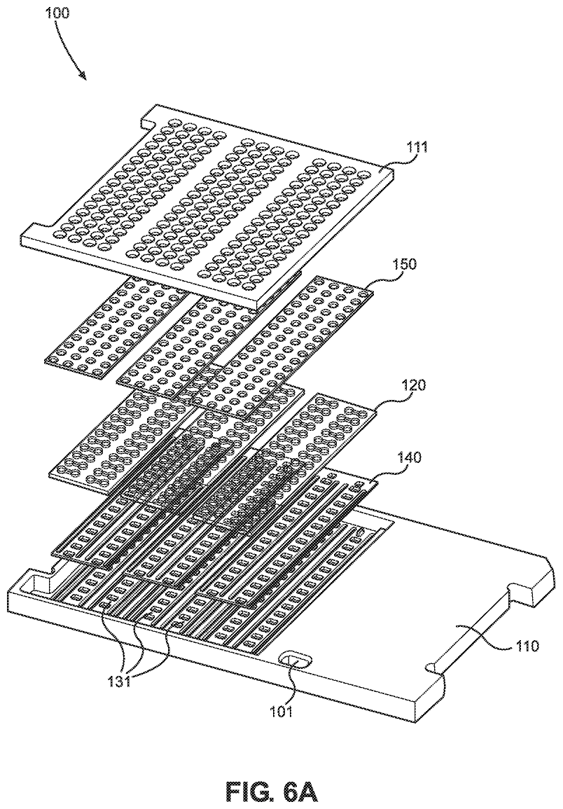

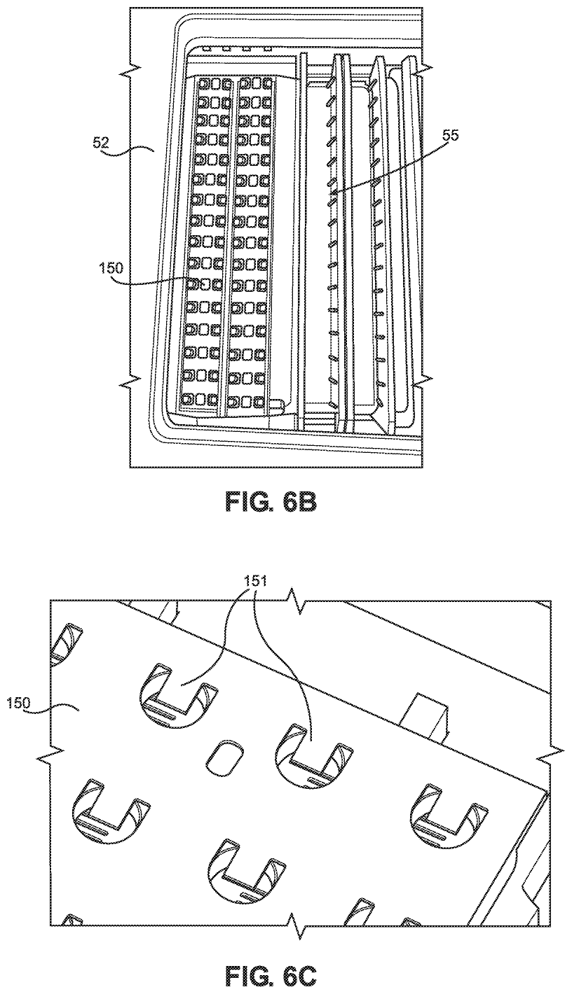

FIG. 6A illustrates in exploded view the chip module of FIG. 5. In general, chip module 100 can include a cover plate 111, a frame 110, one or more sets of assay chips 120 arranged into rows between the cover plate and the frame, and one or more flexible electrode sheets 150 situated between the cover plate and the assay chip(s). One or more sets of pressure sensitive adhesives 140 can be used between various components to facilitate proper fastening and fit. Other adhesive or fastening components may alternatively be used.

Although three assay chips 120 are shown, it will be readily appreciated that more or fewer assay chips may also be used. In various embodiments many assay chips can be used in a single chip module 100 for purposes of volume and efficiency in mass processing, it will be readily appreciated that only one assay chip may be used in some arrangements. One or more recesses 131 can be integrally formed in frame 110 to hold assay chips 120 therein, and such recesses can be sized and shaped to correspond to the sizes and shapes of the assay chips. Other features on frame 110, such as alignment pins, for example, can facilitate alignment and fit with corresponding features on the assay chips 120. Furthermore, although chip module 100 as illustrated is constructed using frame components, it will be readily appreciated that frame components are not necessary for purposes of providing similarly constructed chip modules. For example, chip modules that are substantially integrally formed as single units may also be possible.

FIGS. 6B and 6C illustrate an example flexible electrode arrangement in top plan and top perspective close-up views respectively. As shown in FIG. 6B, flexible electrode sheet 150 can be seen through an access opening 55 of lid 52. For purposes of illustration, all materials above flexible electrode sheet 150 have been removed in FIG. 6B. Flexible electrode sheet 150 can be a single sheet of material having numerous electrodes integrally formed therein. In some arrangements, a single flexible electrode sheet 150 can provide the necessary electrodes or electrical contacts for numerous individual wells in an assay chip module. As shown in FIG. 6C, individual electrode tabs 151 can be positioned above individual wells in the assay chip module, and these tabs can be bent into the wells to provide electrodes for fluid processing.

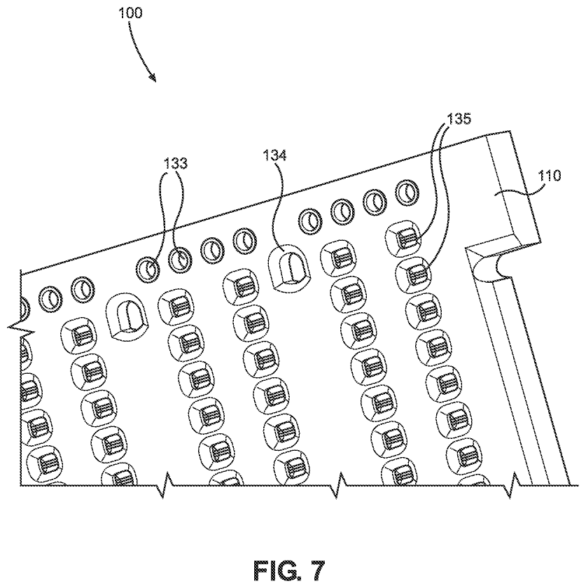

Continuing with FIG. 7 a portion of the chip module of FIG. 5 is shown in bottom perspective view. Various features on the frame 110 of chip module 100 can facilitate operations of the overall system. Electrical pads 133 or contacts along at least one side of the frame can facilitate providing voltage to the various rows of assay chips within chip module 100, as will be readily appreciated. Alignment holes 134 in frame 110 can be configured to mate with corresponding alignment posts on the reception of a corresponding system module to facilitate an accurate fit of chip module 100 within the system module. Imaging windows 135 can be located beneath each assay chip to facilitate analysis of fluid content within the assay chips, as will be readily appreciated.

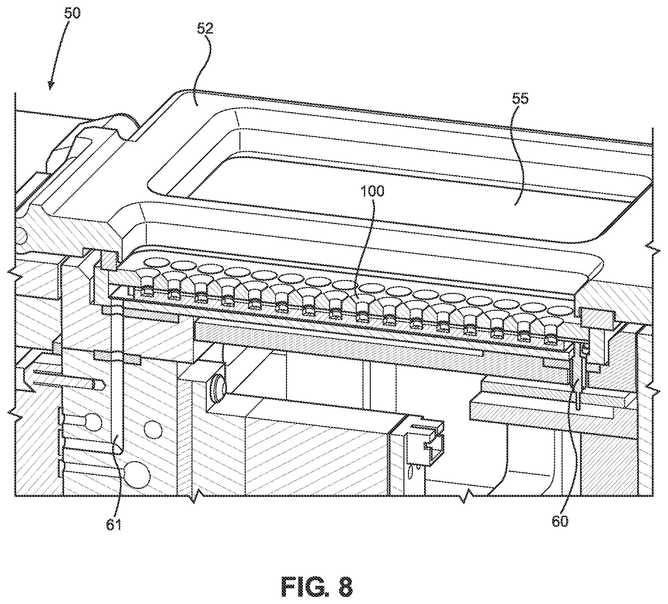

FIG. 8 illustrates in side cross-section view an example chip module within a system module according to one embodiment of the present disclosure. FIG. 8 can correspond to that which is shown in FIG. 4B, where chip module 100 is installed into system module 50 with lid 52 being closed and access to the assay chips within the chip module being provided through open window 55. One or more pogo pins 60 can facilitate electrical connections between the system module 50 and the chip module 100 when the chip module is properly installed within the system module and lid 52 is closed. Various aspiration passages 61 within system module 50 can facilitate aspiration from the assay chips within chip module 100, such as by way of a vacuum applied to a vacuum port within the system module. Regulation of the vacuum can be provided by a series of valves within system module, further details of which are provided in commonly owned U.S. Patent Application No. ______ entitled “SYSTEM MODULES FOR USE WITH FLUID SAMPLE PROCESSING SYSTEMS,” which application is again hereby incorporated by reference in its entirety herein.

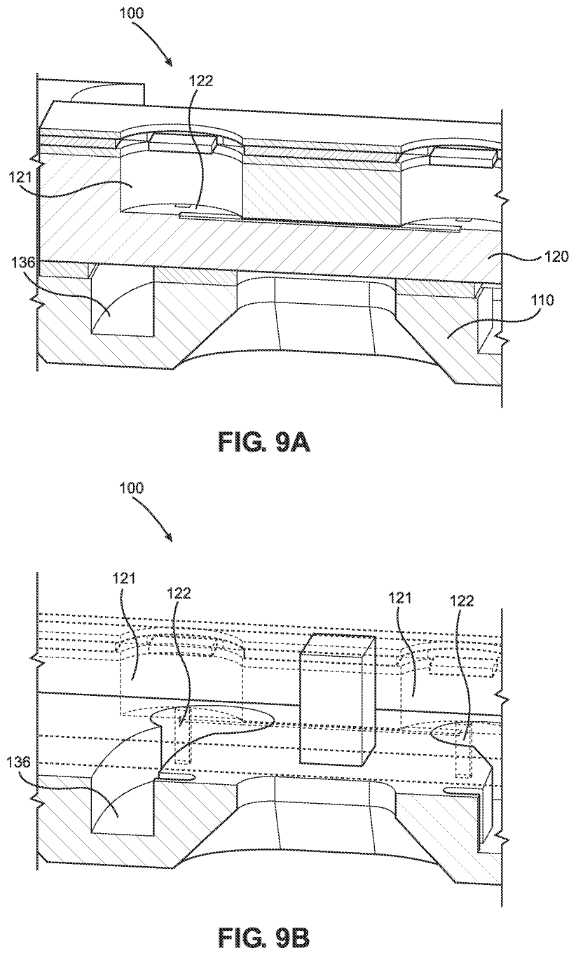

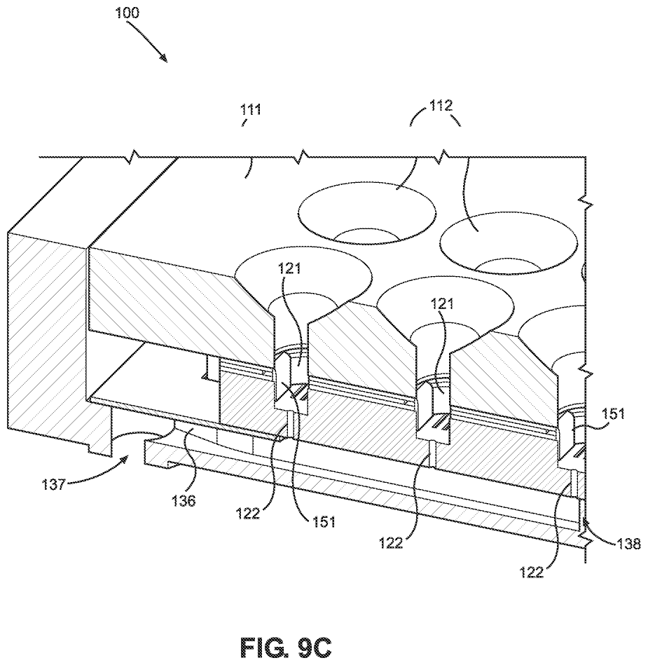

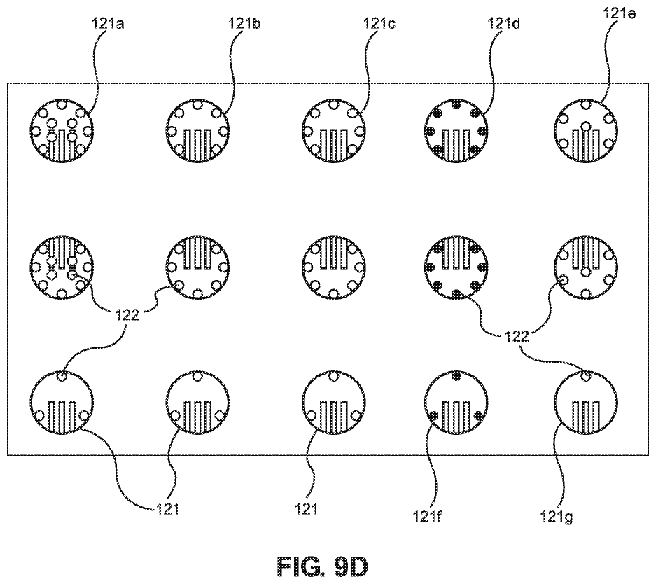

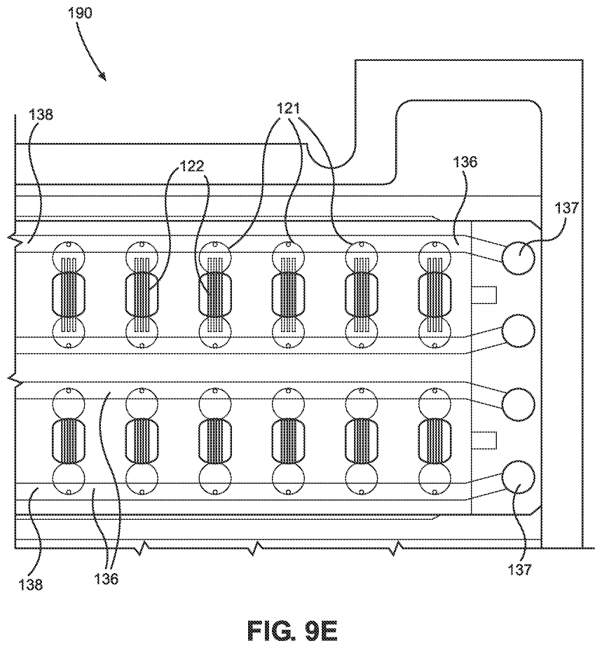

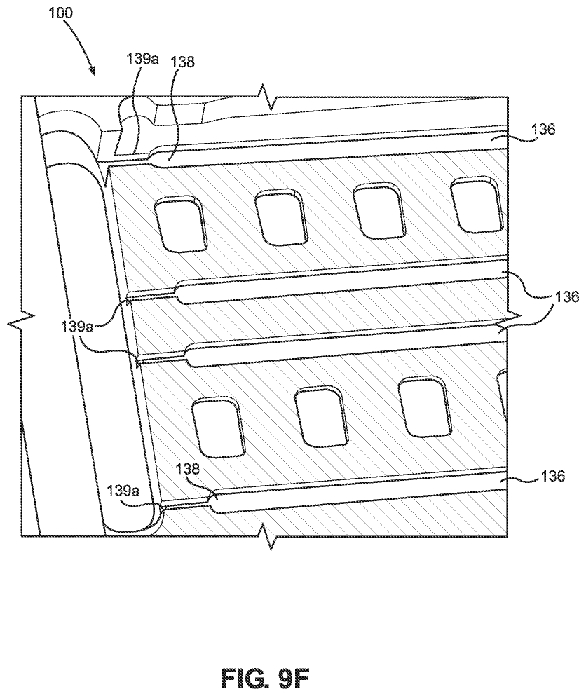

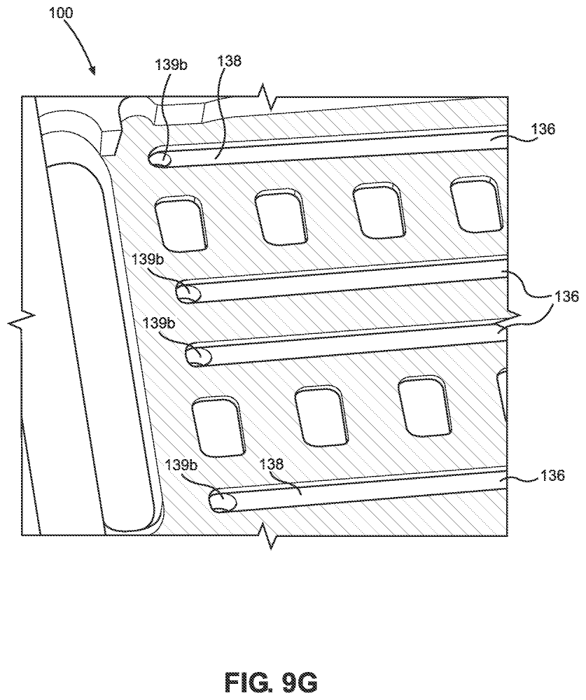

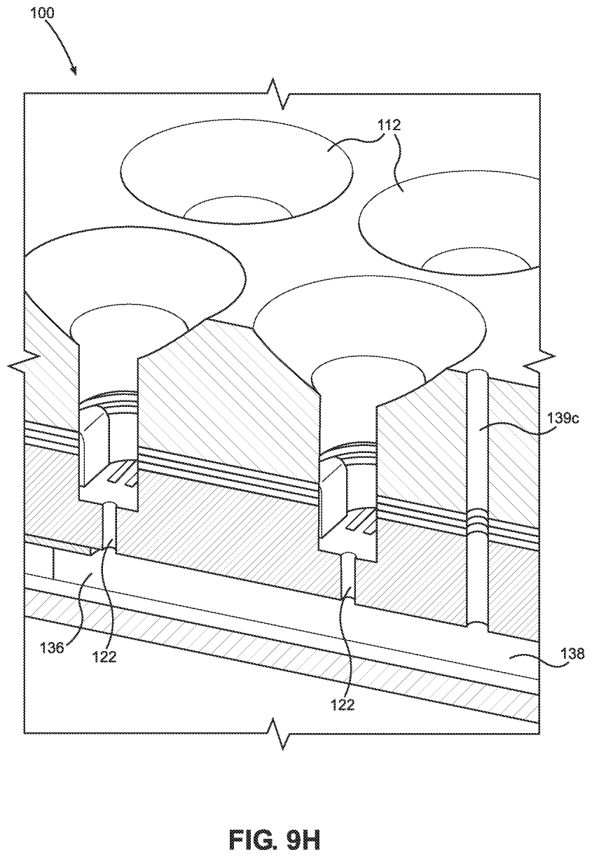

Turning next to FIGS. 9A-9C an example chip module with aspiration channels at the bottoms of its wells is illustrated in side cross-section view, side cross-section and partial cutaway view, and perspective cross-section view respectively. Chip module 100 can include one or more assay chips 120, each assay chip having an integrally formed well 121 configured to hold a fluid of interest. Fluid can be deposited to the top of each well in a conventional manner, such as by way of a pipet. Rather than remove fluid from the top of each well 121, however, the fluid can be aspirated by way of an aspiration channel 122 coupled to the well. Such aspiration channels 122 can also be integrally formed within the assay chips 120 and can connect to the bottoms of the wells 121, for example.

Although aspiration channels 122 have been shown as connecting to the bottoms of the wells 121 for purposes of illustration, it will be readily appreciated that such aspiration channels can be formed to the sides of one or more wells. In various arrangements, wells may have aspiration channels connecting to their bottoms, some wells may have aspiration channels connecting to their sides, and some wells may have both. Other ways of forming aspiration channels coupled to wells are also possible, and it is specifically contemplated that any combination of wells can be used having bottom connected aspiration channels, side connected aspiration channels, and/or otherwise connected aspiration channels.

Fluids can be removed from the wells 121 by way of the aspiration channels 122 by applying a vacuum to the aspiration channels, which can result in a clean and thorough removal of fluids from the wells. This can be facilitated by the inclusion of one or more trenches 136 that can be integrally formed in the frame of chip module 100. Each aspiration channel 122 can connect to a trench 136, and vacuum can be applied to the trench, which then passes the vacuum through the aspiration channel to the well to aspirate fluid therefrom. Each trench 136 can couple to multiple aspiration channels, such that vacuum applied to a given trench then aspirates fluid from all wells 121 having aspiration channels 122 connected to that trench.

In various arrangements, multiple trenches 136 can be used to couple to different sets of wells 121. Vacuum can then be selectively applied to one or more trenches 136 to aspirate fluid from different sets of wells 121 in a controlled manner, as may be desired. In this manner, fluid can be aspirated from multiple wells simultaneously in controlled sets. Fluid can also be aspirated from all wells 121 in chip module 100 simultaneously by applying vacuum to all trenches 136 in the chip module simultaneously. Vacuum can be applied from an associated system module when chip module 100 is installed therein, which can in turn receive vacuum from an outside source and regulate the application of the vacuum through a series of valves that couple aspiration channels within the system module to the various trenches in the chip module.

As shown in FIG. 9C, fluid can be provided into each well 121 through cover openings 112 in cover plate 111 placed atop the chip assays within chip module 100. Electrode tabs 151 in each well 121 and can provide voltage to the fluid of interest while it is held within the well and analyzed or otherwise processed. When analysis and/or other fluid processing is finished and aspiration of fluid from the wells 121 is desired, a vacuum can then be applied to trench 136, which can be a common trench coupled to multiple wells by aspiration channels 122. Application of the vacuum then aspirates all or substantially all of the fluids from all wells 121 coupled to trench 136 by way of aspiration channels 121. Fluid can exit common trench 136 by way of trench outlet 137. In some arrangements, trench outlet 137 can be located at one end of trench 136, with a trench back end 138 located at the opposite end of the trench.

While electrode tabs 151 are shown as parallel with and a part of flexible electrode sheet 150 in FIGS. 6B and 6C, these electrode tabs 151 can be bent into the wells 121 as shown here in FIG. 9C as part of a finished chip module. The flexible nature of electrode tabs 151 bent into each well can provide several advantages. For example, electrode tabs 151 can be pushed or moved without breaking, such as when pipet tips may enter the tops of the wells to dispense fluid into the wells. Further, bending electrode tabs 151 into the wells 121 can ensure that fluid in the wells will contact the electrode tabs.

In general, it can be desirable for fluids not to pass through the aspiration channels while various processing steps are taking place on chip module 100, such as analytic measurements on a fluid of interest. In various embodiments, one or more features can be provided to prevent leakage of fluids from the wells 121 through the aspiration channels 122 before aspiration or fluid removal is desired. For example, the exact geometries of aspiration channels 122 can limit or fully prevent leakage while fluid is being held in the well. In some arrangements, one or more aspiration channels can define a cylindrical channel having a diameter of about 100-300 microns. In various alternative specific arrangements, one or more aspiration channels 122 can define a tapered cylindrical channel that extends from the bottom of a well 121. Such a tapered cylindrical channel can have a diameter of about 150-200 microns where it exits the well and a larger diameter of about 180-240 microns where it meets a trench. Of course, other shapes and dimensions are also possible. Also, the locations of the aspiration channels 122 can be at or near the sides of the wells 121, rather than toward the centers of the wells. In addition, the dimensions of trenches 136 can be about 1 mm wide by about 1 mm deep. Such dimensions and locations have been found to be effective in preventing unwanted leakage of fluids from wells via the aspiration channels. Of course, other dimensions and locations of the aspiration channels are also possible.

In other arrangements, or in addition, hydrophobic materials can be used downstream of the wells, such as in the aspiration channels, and/or trenches. Since natural wicking of fluid from the well 121 into the aspiration channel 122 may tend to occur, the tops, bottoms, and/or sides of the trenches can have and/or can be coated with a hydrophobic material. Alternatively, or in addition, the aspiration channels 122 can have and/or can be coated with a hydrophobic material, such as along the sides of the aspiration channels. Such a hydrophobic material can be, for example, perfluorooctylsilane (“PTFE”), fluroalkysilane, isobutylsilane, or any other suitable hydrophobic material.

When combined with an optimized geometry for the aspiration channels 122, the use of such hydrophobic materials can be especially optimized for preventing fluid leakage from the wells prior to aspirating the fluids by way of vacuum. In addition, the bottoms and/or sides of the wells 121 can have and/or can be coated with a hydrophilic material, such that the fluid tends to remain within the wells until vacuum is applied. For example, where the wells are formed of glass, as can be common for assay chips, the natural hydrophilic nature of glass may be sufficient without any need for a further hydrophilic coating in the wells. Continuing with an illustrative example where the assay chips are formed of glass, then downstream components such as the aspiration channels formed in glass and the underside of the glass assay chips can have a hydrophobic coating over the glass.

Continuing with FIG. 9D, example assay chip wells having different aspiration channel configurations are provided. As will be readily appreciated, any number of aspiration channels may be used for a given assay chip well, and such aspiration channels can have a variety of sizes and shapes and can also be arranged in a variety of patterns. As shown in the top plan view of FIG. 9D, various assay chip wells 121 can all have aspiration channels 122 that are configured in various ways. For example, well 121a can have eleven different large aspiration channels distributed in a pattern about its bottom. Well 121b can have nine different large aspiration channels distributed about its bottom in a different pattern, while well 121c can have seven different large aspiration channels distributed in yet a different pattern. Well 121d can have seven small aspiration channels, while well 121e can have six medium sized aspiration channels. Well 121f can have three small aspiration channels, while well 121g can have a single medium sized aspiration channel disposed at a side wall of the well.

It will be readily appreciated that many other numbers, sizes, and distribution patterns of aspiration channels may be also used. Some or all of these aspiration channels may descend directly from the bottom of the well to a trench located therebeneath. A given chip module can have wells with different aspiration channel arrangements or can have wells that all utilize the same aspiration channel arrangement. It is specifically contemplated that any and all such aspiration channel amounts, sizes, and arrangements in the various wells can be used for a given chip module, as may be desired for purposes of use, results, and manufacturing needs.

FIG. 9E illustrates in top cross-section view an example chip module with aspiration channels at the sides of its wells. As noted above, aspiration channels can be formed at the bottoms of assay chip wells, at the sides of assay chip wells, or both. Chip module 190 provides an alternative embodiment having various aspiration channels 122 formed at the sides of one or more of its wells 121. As shown, chip module 190 can have aspiration channels 122 that are formed at both the sides and bottoms of its wells 121. Each aspiration channel can feed directly or indirectly to a trench 136. Each trench 136 can be located beneath and coupled to multiple wells 121. Each trench 136 can also be coupled to a trench outlet 137, which is in turn can be coupled to a vacuum line within an associated system module to provide vacuum to and aspirate fluids from the wells of chip module 190. Other aspiration arrangements are also possible.

In arrangements where a trench 136 or other similar common flow channel has an outlet 137 at only one end, various issues can occasionally arise with inadequate flushing, flow, or evacuation of liquid material at the other end of the trench. This can result in residual liquid being left in the trench at the trench back end opposite the trench outlet, which can then affect results with respect to some of the wells at the trench back end. Referencing FIG. 9C, for example, fluid flow may ordinarily progress through all wells 121 into common trench 136 and out trench outlet 137, with poor flow or residual fluid issues possibly arising at or near the trench back end 138 since fluid has nowhere to flow at a truly closed off back end. This can result in problems or unreliable readings at the last well 121 of each trench 136 right at the back end 138 of the trench, especially where even a slight amount of trench opening forming the back end extends past the last well in a direction away from trench outlet 137 at the opposite trench end.

To overcome these issues that can occasionally affect the last well 121 of a given common trench 136, one or more vent holes can be provided at the back end 138 of a trench. Such vent holes can then facilitate sufficient flow along the entire trench 136 as fluid is cycled out of the trench, such as by way of a vacuum applied at trench outlet 137. Such a sufficient or full flow along the trench 136 can then result in all fluid being cycled and evacuated out of the trench, including fluid at trench back end 138. Vent holes can be applied in a variety of suitable ways, as shown in FIGS. 9F through 9H, for example.

FIG. 9F illustrates in bottom cross-section view an example chip module with vent holes extending sideways from the back end of a common trench. Here, a rear portion of chip module 100 is shown focusing on the back ends 138 of four separate common trenches 136. It will be understood that trench outlets (not shown) can be located at the opposite end of each trench 136 from the back end 138 regions illustrated. So that each back end 138 does not form any dead zone or low flow area, a sideways extending vent hole 139a can extend from each trench back end 138 through the chip module material to an outside area where ambient air can be sucked through the vent hole when vacuum is applied to evacuate each trench 136.

Continuing with FIG. 9G, an example chip module with vent holes extending downward from the back end of a common trench is shown in bottom cross-section view. Here, rather than have vent holes extend sideways out of the back ends, each trench 136 in chip module 100 can have a downward extending vent hole 139b that provides a vent access from the trench back end 138 through the bottom of the chip material. Again, each vent hole 139b can provide access to ambient air outside the chip module at trench back end 138 such that air can be sucked through the vent hole when vacuum is applied to trench 136 to evacuate liquid therefrom.

As another possible example, FIG. 9H illustrates in perspective cross-section view an example chip module with vent holes extending upward from the back end of a common trench. Here, chip module 100 can be substantially similar to the chip module of FIG. 9C, except that trench 136 can have an upward extending vent hole 139c located at trench back end 138. Vent hole 139c can extend from trench 136 through the chip module 100 to a top surface thereof. As in the foregoing examples, vent hole 139c can provide access to ambient air outside the chip module such that air can be sucked through the vent hole into the trench 136 at trench back end 138 when vacuum is applied to the trench.

In each of the foregoing examples of FIGS. 9F-9H, vent holes can be provided at the trench back end 138, such that vacuum applied at the opposite end of the trench (e.g., at trench outlet 137) then results in the entire trench being swept and evacuated of fluid. This can result in no “dead zones” in the trench and little to no residual fluid left in the trench, such that all of the chip module wells can be reliably used. Of course, only one of vent holes 139a, 139b, or 139c is necessary for a given trench, although more than one can be used if desired. Alternatively, one or more other vent holes may be used separately or in addition to the example types of vent holes shown in FIGS. 9F-9H.

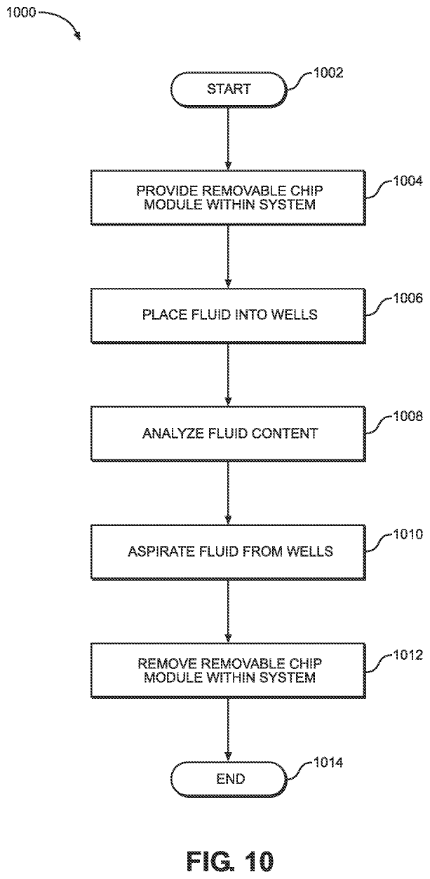

Lastly, FIG. 10 presents a flowchart of an example method of processing fluid samples. Such processing can involve the detection, identification and quantification of small molecules and macromolecules, although other fluid processing applications are also possible. In various embodiments, method 1000 can be applied using the various systems, modules, apparatuses and features provided above.

After a start step 1002, a first process step 1004 can involve providing a removable chip module within a fluid sample processing system. As noted above, the removable chip module can include one or more assay chips arranged into one or more rows, and the one or more assay chips can include one or more wells configured to hold fluid therein and one or more aspiration channels connected to the one or more wells. In various arrangements, providing the removable chip module can involve opening the lid on a system module, placing the chip module in a designated area within the system module, and then closing the lid on the system module. This process can be automated or can be manually accomplished.

At a subsequent process step 1006, fluid can be placed into the one or more wells. This can involve, for example, a pipet system placing the fluid into the tops of the wells. As will be readily appreciated, the pipet system can be robotically controlled, such as by a robotic arm that is automatically operated by a software program on an associated computer.

At a following process step 1008, fluid content in the placed fluid can be analyzed. This can take place using any of various well-known fluid analysis procedures. Fluid can be analyzed, for example, for the presence of and characteristics of various molecules and macromolecules. Analyzing fluid content can be accomplished, for example, by way of applying a voltage to electrodes that are in the wells, and then observing characteristics of the fluid as a result, as will be readily appreciated.

At the next process step 1010, the fluid can be aspirated from the wells. This can involve aspirating or otherwise removing the fluid from the bottoms and/or the sides of the wells, rather than from the tops, which can be accomplished using the various components and features disclosed above, such as a chip module having aspiration channels at the bottoms and/or the sides of the wells. Aspiration can be facilitated by applying a vacuum to the bottoms and/or the sides of the wells, as set forth above. Aspiration of the fluid from the wells can take place for multiple wells simultaneously. In some arrangements, all wells can be aspirated at once. In some embodiments, a subset of all of the wells can be aspirated simultaneously, such as by pairs sharing a common trench or by rows.

At a following process step 1012, the removable chip module can be removed from the system. This can involve opening the lid on a system module and then removing the chip module from the system module. Similar to providing the removable chip module, this process can be automated or can be accomplished manually. Where automated, one or more robotic arms or other automated components can remove the chip module. As noted above, opening the lid on the system module can involve pressing a button release or other actuation component. The method then ends at end step 1014.

It will be appreciated that the foregoing method may include additional steps not shown, and that not all steps are necessary in some embodiments. For example, additional steps may include installing the system module into an existing fluid sample processing system, as well as collecting and disposing of waste fluids. Other process steps can involve an initial removal of a buffer or storage fluid in the chip module, as wells as one or more cycles of placing fluid and aspirating fluid prior to analyzing fluid content of a fluid of interest, such as during a flush cycling process. Other steps not included here can include imaging and detailed fluid analysis steps that can be involved in fluid processing, as will be readily appreciated by one of skill in the art. Furthermore, the order of steps may be altered as desired, and one or more steps may be performed simultaneously. For example, process steps 1006 and 1010 can be performed simultaneously, albeit on different sets of wells at any given time. In various arrangements, the process steps of placing, analyzing, and aspirating can all be automatically performed by a robotic system.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the appended claims.

What is claimed is:

1. A fluid sample processing system, comprising:
an analytic component; and
a removable chip module configured to be coupled to the analytic component, the removable chip module having one or more assay devices arranged into one or more rows, the one or more assay devices including:
one or more wells configured to hold fluid therein, and
one or more aspiration channels connected to the one or more wells, wherein the one or more aspiration channels are configured to aspirate fluid from the bottoms or the sides of the one or more wells.

2. The fluid sample processing system of claim 1, wherein the one or more assay devices are arranged within a frame in the removable chip module.

3. The fluid sample processing system of claim 1, wherein the removable chip module further includes one or more trenches beneath the one or more aspiration channels, the one or more trenches being configured to facilitate the aspiration of fluid from multiple wells.

4. The fluid sample processing system of claim 3, wherein the aspiration from multiple wells is configured to occur simultaneously.

5. The fluid sample processing system of claim 1, wherein at least one of the one or more aspiration channels defines a cylindrical channel that extends from the bottom of a well and has a diameter of about 100-300 microns.

6. A chip module configured for use with a fluid sample processing system, the chip module comprising:
one or more assay devices arranged into one or more rows, the one or more assay devices including:
one or more wells configured to hold fluid therein, and
one or more aspiration channels connected to the one or more wells, wherein the one or more aspiration channels are configured to aspirate fluid from the bottoms or the sides of the one or more wells.

7. The chip module of claim 6, wherein the one or more assay devices are arranged within a frame in the chip module.

8. The chip module of claim 6, wherein the chip module is configured to be removable from the fluid sample processing system.

9. The chip module of claim 6, further comprising:
one or more trenches beneath the one or more aspiration channels, the one or more trenches being configured to facilitate the aspiration of fluid from multiple wells.

10. The chip module of claim 6, wherein the one or more wells are configured to hold the fluid therein without the fluid passing through the one or more aspiration channels during analytic measurements on the fluid.

11. The chip module of claim 10, wherein at least a portion of the chip module downstream of the one or more wells includes a hydrophobic material configured to prevent the fluid from entering therein during analytic measurements on the fluid.

12. The chip module of claim 11, wherein at least a portion of the one or more aspiration channels includes a hydrophobic material configured to prevent the fluid from entering therein during analytic measurements on the fluid.

13. The chip module of claim 6, wherein the aspiration from multiple wells is configured to occur simultaneously.

14. The chip module of claim 13, wherein the aspiration from multiple wells is configured to occur by applying a vacuum beneath the one or more aspiration channels.

15. The chip module of claim 6, wherein at least one of the one or more aspiration channels defines a cylindrical channel that extends from the bottom of a well and has a diameter of about 100-300 microns.

16. The chip module of claim 6, further comprising:
at least one flexible electrode arrangement having one or more electrode components configured to provide an electrical charge to the one or more wells.

17. The chip module of claim 16, wherein the one or more electrode components comprise one or more tabs configured to bend into the one or more wells.

18. A method of processing fluid samples, the method comprising:
providing a removable chip module within a fluid sample processing system, the removable chip module including one or more assay devices arranged into one or more rows, the one or more assay devices including one or more wells configured to hold fluid therein and one or more aspiration channels connected to the one or more wells;
placing a fluid into the top of each of the one or more wells;
analyzing content in the fluid within the one or more wells; and
aspirating the fluid from the bottom or the side of each of the one or more wells.

19. The method of claim 18, wherein the aspirating is facilitated by applying a vacuum to the bottom or the side of each of the one or more wells.

20. The method of claim 18, wherein the placing, the analyzing, and the aspirating are all automatically performed by a robotic system.

21. The method of claim 18, wherein the aspirating of the fluid occurs simultaneously for multiple wells.

22. The method of claim 18, further comprising the step of:
removing the removable chip module from the fluid sample measurement system.
